(19) United States
(12) Patent Application Publication
(10) Pub. No.: US 2005/0059415 A1
(43) Pub. Date: Mar. 17, 2005

(54) Wireless network capable of allowing coincident mobile terminating location request and mobile originating transactions

(75) Inventors: Daniel Easo, Boynton Beach, FL (US); Julio Cesar Castella, Boca Raton, FL (US); Guilherme Giacon, Boca Raton, FL (US)

Correspondence Address: Elsa Keller;Siemens Corporation, Intellectual Property Department, 170 Wood Avenue South, Iselin, NJ, 08830, US

(73) Assignee: Siemens Information and Communication Mobile, LLC

(21) Appl. No.: 10/663,387

(22) Filed: Sep. 16, 2003

(51) Int. Cl. H04Q 7/20

(52) U.S. Cl. 455/456.3; 455/414.3; 455/456.1

(57) ABSTRACT

A wireless communications network with Mobile Subscriber (MS) units in cells serviced by base transceiver stations (BTSs). Mobile switching centers (MSC) administer to base station controllers (BSC) which administer to neighboring BTSs. A Serving Mobile Location Center (SMLC) performs positional measurement for the MS units. Gateway Mobile Location Centers (GMLCs) provides an access node for mobile terminating location requests (MT-LR) from external LCS clients. Even after origination of a MT-LR for a particular MS, mobile originated (MO) requests from the particular MS unit are completed normally while and before the MT-LR completes.

### BACKGROUND OF THE INVENTION

1. Field of the Invention

The present invention is related to a wireless communications network and more particularly to a wireless communications networks with location services capabilities.

2. Background Description

Wireless communication systems, such as those supporting Global System for Mobile Communication (GSM), Time Division Multiple Access (TDMA) and Code Division Multiple Access (CDMA) technologies, employ a base transceiver station (BTS) in each cell or cell sector. Each base station supports wireless communication with mobile subscriber (MS) units in that cell. Typical MS communications units are, for example, cellular telephone (cell phone) handsets, PDAs, laptops and other devices with a wireless communications interface. Widespread acceptance of such wireless communications systems has led some to dispose of or forego a landline system, relying solely on their cell phones for communications. In an emergency, a quick cell phone connection may be critical, e.g., in placing a 911 call.

Increasingly, state of the art land based wireless communications technologies (e.g., GSM) are including location and positioning capabilities such as Global Positioning System (GPS) capability or a lower cost enhanced Cell IDentifier/Timing Advance (eCI-TA) measurement capability. Typical GPS measurements are accurate to within 10 m, but are seldom available in enclosed areas, e.g., buildings. Since state of the art wireless communications technologies such as eCI-TA can penetrate buildings, they have been combined with GPS to extend the reach of positioning devices and have improved positional accuracy. Essentially, an eCI-TA database is created using network planning tools to determine and collect timing advance and power measurements within a particular cell. A positioning algorithm locates user positions within the cell from predicted database values. Using eCI-TA data, a MS unit can be located to within 100 meters (100 m) in dense urban areas. These measurements have also found use in what are known as location services (LCS) such as, value added services, emergency services and/or legal and lawful interception services that allow continuously tracking individual mobile devices. These LCS should not interfere with emergency calls and vice versa.

Thus, there is a need in a wireless communications network to freely locate individual subscribers and, simultaneously allow those subscribers access to network services.

### SUMMARY OF THE INVENTION

It is a purpose of the invention to improve mobile subscriber (MS) service;

It is another purpose of the invention to allow a MS to originate services while a location service (LCS) request to that MS is being processed in a wireless network;

It is yet another purpose of the invention to insure that a MS can place an emergency call even when a LCS request to that MS is being processed.

The present invention relates to a wireless communications network with Mobile Subscriber (MS) units in cells serviced by base transceiver stations (BTSs). Mobile switching centers (MSC) administer to base station controllers (BSC) which administer to neighboring BTSs. A Serving Mobile Location Center (SMLC) performs positional measurement for the MS units. Gateway Mobile Location Centers (GMLCs) provides an access node for mobile terminating location requests (MT-LR) from external LCS clients. Even after origination of a MT-LR for a particular MS, mobile originated (MO) requests from the particular MS unit are completed normally while and before the MT-LR completes.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a wireless data communications system or network according to a preferred embodiment of the present invention;

FIGS. 2A-B shows examples of how a preferred embodiment network allows MO transactions completion, even after a MT-LR and before completion of the request.

### DESCRIPTION OF PREFERRED EMBODIMENTS

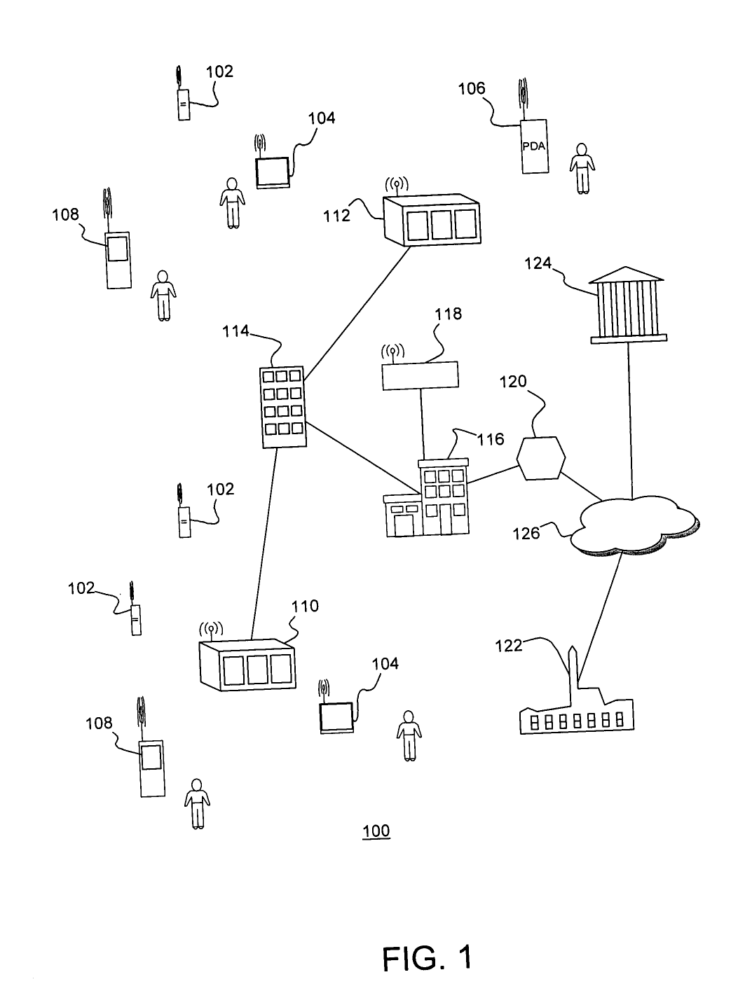

Turning now to the drawings and, more particularly, FIG. 1 shows an example of a wireless communications system or wireless network 100 (e.g., Global System for Mobile Communication (GSM)) providing personal communications services (PCS) to local Mobile Subscriber (MS) units or wireless communications devices 102, 104, 106, 108 according to a preferred embodiment of the present invention. Unlike current state of the art mobile networks, a preferred embodiment mobile network 100 can allow mobile originating (MO) transactions from the MS units 102, 104, 106, 108 even when a prior Mobile Terminating Location Request (MT-LR) is being processed or in progress. The present invention overcomes a heretofore unknown shortcoming within the current wireless network standards that forces a MS to wait until the prior MT-LR (started in idle mode) completes, placing the MS on hold for any Mobile Originating (MO) transactions, e.g., an Emergency Call.

A preferred wireless network or Public Land Mobile Network (PLMN) 100 is a universal mobile telecommunications system (UMTS) that includes one or more wireless cells, each serviced by a local base transceiver station (BTS) 110, 112. In particular, the present invention has application to any location services (LCS) capable wireless network, such as a GSM network, a Time Division Multiple Access (TDMA) network, Code Division Multiple Access (CDMA) network or an equivalent network. The local base stations 110, 112 communicate wirelessly with local MS units 102, 104, 106, 108 in the particular cell. MS units may include cellular phone handsets (cell phones) 102, 108 or other devices with a wireless communications interface, e.g., a computing device such as a personal digital assistant (PDA) 106, laptop computer or tablet computer 104 and etc. Base station controllers (BSCs) 114 administer to the base transceiver stations 110, 112. A mobile switching center (MSC) 116 interfaces other MSCs (not shown) and, through the base station controllers 114, to the base transceiver stations 110, 112. The MSCs 116 administer handovers to neighboring BTSs 110, 112, carries out call metering and provides comfort functions within the network 100 and, also, administers other subscriber services within the network.

A Serving Mobile Location Center (SMLC) 118 is either a separate network element as shown in this example or may be integrated in the BSC 114 and performs the positional measurement for the MS units 102, 104, 106, 108 by managing the overall co-ordination and scheduling of resources required for determining the location of a particular MS unit 102, 104, 106, 108. The SMLC 118 also estimates the final location and achieved accuracy and may control a Location Measurement Unit ((LMU) not shown) for obtaining radio interface measurements to locate or help locate particular MS 102, 104, 106, 108. In addition, the SMLC 118 and one or more Gateway Mobile Location Centers (GMLCs) 120 support LCS. The GMLCs 120 provide an access node for external LCS clients, e.g., value added services 122, emergency services and/or legal and lawful interception services 124. In this example LCS services 122, 124 are shown in communication with the GMLC 120, e.g., over a network 126, e.g., the Internet. However, this is for example only and any suitable form of communication may be employed. Value added services 122 include things such as route planning information. Legal and lawful interception services 124 are services that might be used as evidence in legal proceedings. Emergency services provide location information for organizations such as fire and ambulance service. According to a preferred embodiment of the present invention, MO transactions are allowed to originate and complete even in the presence of an ongoing MT-LR.

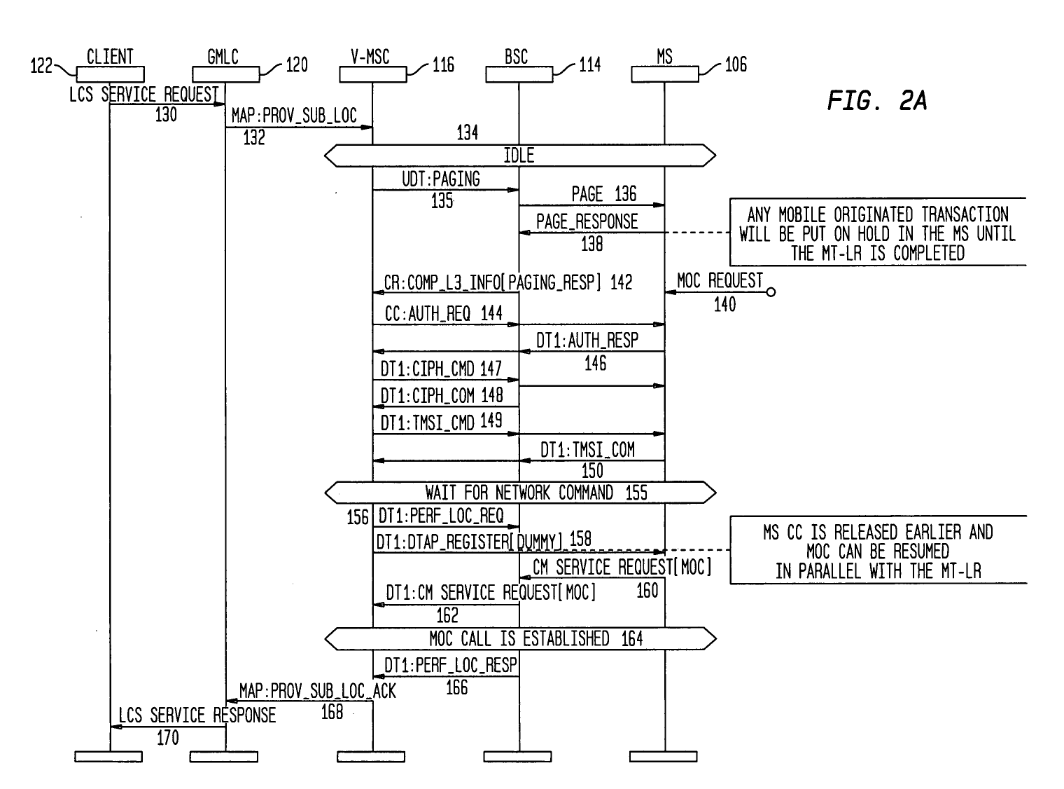

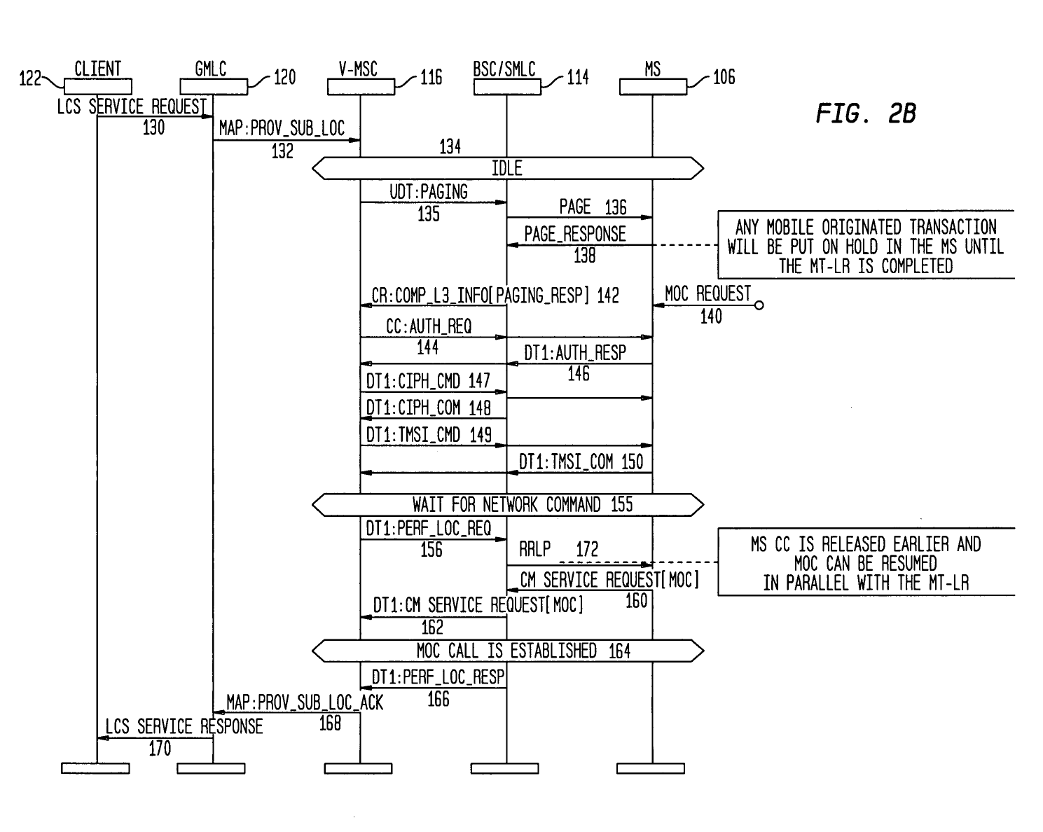

FIGS. 2A-B show two examples with like elements labeled identically, showing how a preferred embodiment network, such as the network 100 example of FIG. 1, allows MO transactions completion, even after a MT-LR 130 and before completion of the request, thereby avoiding a grave problem in prior art wireless network. In FIG. 2A, a faked Call Control (CC) connection, using a new or existing message, originates in parallel to the MT-LR request in the visited MSC (V-MSC) 116 currently serving the MS. In FIG. 2B a faked radio resource location protocol (RRLP) request originates, e.g., in the BSC 114 or SMLC 118, in parallel with the MT-LR request.

So, after the LCS client, e.g., value added services 122, requests LCS to initiate the MT-LR in 130, the GMLC 120 may request routing information stored in a Home Subscriber Server (HSS) or Home Location register (HLR). The HSS (not shown) includes the HLR as well as Domain Name Servers (DNS) and security and network access databases. The HLR is a database that provides routing information for MT calls and short message service (SMS). After performing registration authorization, the GMLC 120 forwards positioning requests in 132 to the MSC. At this point if the MS 106 is Idle 134, then the MSC 116 starts passes a paging request 135 to the BSC 114 which forwards the Page 136 to the MS 106. The MS 106 responds with Paging Response 138 and any Mobile Originating transactions (MO) 140 are queued, at least until channel security is established. As a result page response 138, the BSC 114 forwards Complete Layer 3 Information 142 to the MSC 116. The MSC 116 initiates Security procedures beginning with an Authentication request 144. When the correct authentication response 146 is received, the MSC sends a Ciphering command 147. When the MSC 116 receives a cipher complete 148, it sends a TMSI Reallocation. The security procedure is complete when the MSC 116 receives a TMSI reallocation complete in 150. When the security procedure completes in 150, the MS 106 places the MM layer into a “Wait for Network Command” state 155. In this state 155, the MS 106 is waiting for a CC message from the Network, i.e., from MSC 116 or BSC 114. Since, previously CC messages were not sent from either the MSC 116 or BSC 114 to the MS 106 during the MT-LR procedure, the MS 106 stayed in the “Wait for Network Command” state 155, as long as MT-LR is finished (perhaps as much as 30 seconds). The MS 106 waited in this state 155, which blocked or postponed initiating MO transactions, e.g., blocked Emergency E911 calls, until the MT-LR procedure finished.

LCS positioning methods, for example, using time difference measurements of the radio signals, such as enhanced Cell ID/Timing Advance (eCI-TA), Uplink Time Difference of Arrival (UTDOA) or Service Area Identifier (SAI), may take 10 to 25 seconds to complete a MT-LR transaction. During that time, in a prior art system, the MS queues any MO related activity till the MT-LR transaction completes. So, depending on the type of positioning method selected and network congestion, the subscriber waits 10 seconds or more before any MO transaction can be initiated, which is unacceptable for an emergency call, e.g., 911. The likelihood of such an occurrence is increasing as LCS usage increases, which is occurring rapidly for Emergency and Commercial Location based services. Further, MT-LRs occur more frequently when a MS is being tracked continuously, e.g., by Lawful Interception Agencies or for Commercial Location Services purposes. Thus, as shown hereinbelow, the present invention overcomes this shortcoming in the prior art by allowing MO transactions even in the presence of currently open MT-LRs.

Advantageously, however, in the example of FIG. 2A, MO requests are serviced even though the MT-LR transaction has not yet completed. A faked CC connection begins in 158 with the MSC 116 sending a dummy or fake register message 158 to the MS 106 using Direct Transfer Application Part (DTAP) application protocol. The MS 106 ignores or rejects the fake or dummy register message 158, but as side effect, it can process the MO request in 160 with a connection management (CM) service request from the MS 106 to the BSC 114. In 162 the BSC 114 forwards the MO request to the MSC 116 to establish and stabilize the MO transaction in 164 without being placed on hold and so, without delaying the MO service request. Subsequently or coincidentally, in 166 the response to the MT-LR begins when the LCS specific message is provided to the SMLC. In 168 the MSC 116 forwards the positional information to the GMLC 120. Finally, in 170 the GMLC 120 forwards the MT-LR response to the LCS client 122.

Similarly, in the example of FIG. 2B, in 172 a faked RRLP request to the MS 106 originates in the BSC or SMLC 174 after perform location request 156. This allows the MS 106 to continue the MO request 140 with a connection management (CM) service request 160 from the MS 106 to the BSC/SMLC 174 without placing the MS 106 on hold and so, without delaying the MO service request. Likewise in 162 the BSC/SMLC 174 forwards the MO request to the MSC 116 to establish the MO transaction in 164. Subsequently or coincidentally, in 166 the response to the MT-LR begins when the LCS specific message is provided to the BSC/SMLC 174. In 168 the MSC 116 forwards the positional information to the GMLC 120. Finally, in 170 the GMLC 120 forwards the MT-LR response to the LCS client 122.

Thus, the present invention avoids a grave problem inherent in prior art wireless networks and the potentially disastrous consequences that might arise from placing on hold all MO transactions made after a MT-LR in idle mode and before completion of the request. A long (e.g., 30 second) hold might allow an accident victim to lapse into unconsciousness without placing the call or give a would-be attacker time to snatch the victim's cell phone away and terminate the call. Frequent holds in MO requests might act to tip off a suspect that authorities are tracking him/her. Further, this problem is a shortcoming within the wireless network standards and so, is present equipment from all mobile infrastructure major vendors and so, must be addressed by all systems with location based network services.

Advantageously, the present invention offers a network based solution that works for existing and future hardware. Further, under some circumstances, the present invention optimizes the signal flow between the core network, radio access and handsets. This optimization occurs because handsets can establish MO transactions simultaneously with MT-LRs and without releasing the radio resource. In addition, the present invention has application to TDMA and CDMA networks, especially in networks using only network based positioning methods or where positioning may take a relatively long time to complete.

While the invention has been described in terms of preferred embodiments, those skilled in the art will recognize that the invention can be practiced with modification within the spirit and scope of the appended claims.

1. A wireless communications network comprising:
a plurality of Mobile Subscriber (MS) units;
at least one base transceiver station (BTS), each BTS communicating wirelessly with ones of said MS units in a network cell;
at least one mobile switching center (MSC) administering to said at least one BTS and to any neighboring ones of said at least one MSC; and
at least one Gateway Mobile Location Center (GMLC) supporting location services (LCS) and providing an access node for LCS service requests, wherein requests for services from one MS unit of said plurality of MS units are not placed on hold until a LCS request to said one MS unit completes.

2. A wireless communications network as in claim 1, wherein a response to said request for services is provided to said one MS unit before a response is provided for said LCS request.

3. A wireless communications network as in claim 1, wherein upon said request for services said MSC initiates a faked call control connection to said one MS unit.

4. A wireless communications network as in claim 1, further comprising:
at least one base station controller (BSC) between a plurality of BTSs and said MSC, each said BSC administering to said plurality of BTSs, and wherein upon said request for services, said BSC initiates a faked radio resource location protocol (RRLP) request to said one MS unit.

5. A wireless communications network as in claim 1, further comprising:
a Serving Mobile Location Center (SMLC) performing positional measurement for said plurality of MS units.

6. A wireless communications network as in claim 5, wherein upon said request for services said SMLC initiates a faked radio resource location protocol (RRLP) request to said one MS unit.

7. A wireless communications network as in claim 1, wherein said at least one cell is a plurality of cells, and said LCS service requests comprise requests for value added services, emergency services and legal and lawful interception services.

8. A wireless communications network as in claim 1, wherein said LCS service requests are mobile terminating location request (MT-LR) and said requests for services are mobile originated (MO) requests.

9. A wireless communications network as in claim 1, wherein said wireless communications network is a Global System for Mobile Communication (GSM) network.

10. A wireless communications network comprising:
a plurality of Mobile Subscriber (MS) units;
a plurality of base transceiver stations (BTSs), each BTS in a network cell communicating wirelessly with ones of said MS units in said cell;
a plurality of base station controllers (BSCs) administering to ones of said plurality of BTSs;
a plurality of mobile switching centers (MSC) administering to said plurality of BSCs and to any neighboring ones of said plurality of MSCs;
at least one Serving Mobile Location Center (SMLC) performing positional measurement for ones of said plurality of MS units; and
at least one Gateway Mobile Location Center (GMLC) providing an access node for mobile terminating location requests (MT-LRs) from external LCS clients, wherein mobile originated (MO) requests for services from ones of said plurality of MS units are not placed on hold until MT-LRs to requesting said ones of said plurality of MS units complete.

11. A wireless communications network as in claim 10, wherein said wireless communications network is a Global System for Mobile Communication (GSM) network and responses to said MO requests are provided before a response is provided for a corresponding said MT-LR.

12. A wireless communications network as in claim 10, wherein upon said request for services said MSC initiates a faked call control connection to said requesting ones of said plurality of MS units.

13. A wireless communications network as in claim 10, wherein upon said request for services one BSC initiates a faked radio resource location protocol (RRLP) request to said requesting ones of said plurality of MS units.

14. A wireless communications network as in claim 10, wherein upon said request for services said SMLC initiates a faked radio resource location protocol (RRLP) request to said requesting ones of said plurality of MS units.

15. A wireless communications network as in claim 10, wherein said external LCS clients request location services comprising: value added services, emergency services and legal and lawful interception services.

16. A method of managing a wireless communications network, said method comprising the steps of:
a) initiating a mobile terminating location request (MT-LR) for a particular mobile subscriber (MS) unit;
b) idling the mobility management (MM) layer of said particular MS unit;
c) initiating a mobile originated (MO) request for services from said particular MS unit;
d) processing said MO request; and
e) providing a response to said MT-LR.

17. A method of managing a wireless communications network as in claim 16, wherein said response is provided in step (e) to said MT-LR after a response is provided to said MO request.

18. A method of managing a wireless communications network as in claim 16, wherein the step (d) of processing said MO request comprises originating a faked Call Control (CC) connection in parallel with said MT-LR.

19. A method of managing a wireless communications network as in claim 18, wherein said faked CC connection originates in a visited mobile switching center (V-MSC) currently serving a mobile subscriber originating said MO request.

20. A method of managing a wireless communications network as in claim 16, wherein the step (d) of processing the MO request comprises originating faked radio resource location protocol (RRLP) request in parallel with the MT-LR request.

21. A method of managing a wireless communications network as in claim 20, wherein said faked RRLP request originates in a base station controller (BSC) currently serving a mobile subscriber originating said MO request.

22. A method of managing a wireless communications network as in claim 20, wherein said faked RRLP request originates in a Serving Mobile Location Center (SMLC).

23. A method of managing a wireless communications network as in claim 16, wherein MT-LR is a request for location service (LCS).

24. A method of managing a wireless communications network as in claim 23, wherein said request for LCS provides tracking data for a mobile subscriber.

25. A method of managing a wireless communications network as in claim 16, wherein said wireless communications network is a Global System for Mobile Communication (GSM) network.
